(19) United States
(12) Patent Application Publication
(10) Pub. No.: US 2010/0228748 A1
(43) Pub. Date: Sep. 9, 2010

(54) DATA SUBSET RETRIEVAL FROM A QUEUED MESSAGE

(75) Inventor: Bret Dixon, South Perth (AU)

Correspondence Address: CAREY, RODRIGUEZ, GREENBERG & PAUL, LLP;STEVEN M. GREENBERG, 950 PENINSULA CORPORATE CIRCLE, SUITE 2022, BOCA RATON, FL, 33487, US

(73) Assignee: INTERNATIONAL BUSINESS MACHINES CORPORATION, Armonk, NY (US)

(21) Appl. No.: 12/391,176

(22) Filed: Feb. 23, 2009

(51) Int. Cl. G06F 17/30; G06F 7/00

(52) U.S. Cl. 707/754; 707/E17.014; 707/769

(57) ABSTRACT

Embodiments of the present invention provide a method, system and computer program product for data subset retrieval from a queued message. In an embodiment of the invention, a method for data subset retrieval from a queued message can include receiving from a requesting application a message retrieval request for a message in a message queue and retrieving the message from the message queue. A field specified by the request can be identified and only data in the message corresponding to the identified field specified by the request can be transmitted to the requesting application.

### BACKGROUND OF THE INVENTION

1. Field of the Invention

The present invention relates to the field of message queue and sequential file management and more particularly to the programmatic access to a message queue and also programmatic access to a sequential file.

2. Description of the Related Art

In the field of information technology, a message queue is a software-engineering component used for inter-process communications or inter-thread communications. The component employs a queue into which messages can be placed by a messenger and from which messages can be retrieved by a designated recipient. In this regard, the message queue can be a communicative component enabling asynchronous messaging as between the messenger and the designated recipient. Operationally, the message queue can support multiple messengers and recipients such that asynchronous communications can be achieved for a group of participants.

The asynchronous nature of the message queue provides for an ideal technology coupler for disparate technologies. Specifically, so long as separate technologies can access the message queue, the separate and disparate technologies can engage in message passing thereby enabling communications. In particular, the message queue can expose different method calls through an application programming interface (API) for opening, writing to, reading from, and closing the message queue. Each application in turn can include logic to invoke a sequence of the method calls in order to either place a message into the message queue, or to retrieve a message from the message queue. Specifically, in operation, upon request, the API can search a message queue for an available message and can return the same to the requesting logic.

Of note, each message when placed in a queue can be a binary array of data having a specific length that can range to a maximum size allowable by the queuing system. When a retrieval request is issued by an application program, if the message is available, the message is returned to the requesting application program in full form (e.g. the entire length of the binary array), or as a truncated version of the binary array (e.g. only the first n bytes of the binary array as specified by the application program in its request). Notwithstanding, on occasion it would be preferred to retrieve a specific intermediate portion of the binary array of the queued message.

### BRIEF SUMMARY OF THE INVENTION

Embodiments of the present invention address deficiencies of the art in respect to message retrieval in a messaging queue and provide a novel and non-obvious method, system and computer program product for data subset retrieval from a queued message. In an embodiment of the invention, a method for data subset retrieval from a queued message can include receiving from a requesting application a message retrieval request for a message in a message queue and retrieving the message from the message queue. One or more fields specified by the request can be identified and only data in the message corresponding to the identified field or fields specified by the request can be transmitted to the requesting application.

In one aspect of the embodiment, a specified template can be determined from the request. Subsequently, the specified template can be loaded into memory. As such, data in the retrieved message can be mapped to a field in the template corresponding to the field specified by the request. To the extent that multiple fields had been specified by the request, data for each field in the retrieved message can be mapped individually to one of the fields in the template corresponding to the field specified by the request. In either circumstance, the mapped data can be transmitted to the requesting application as a data subset.

In another embodiment of the invention, a message queuing data processing system can be provided. The system can include a host computing system including a processor and memory. A message queue also can be coupled to the host computing system. Finally, a data subset retrieval module can execute in the host computing system. The module can include program code enabled to receive from a requesting application a message retrieval request for a message in the message queue, to retrieve the message from the message queue, to identify a field or multiple fields specified by the request, and to transmit to the requesting application only data in the message corresponding to the identified field or fields specified by the request.

Optionally, different templates can be provided. Each template can include different fields in a message in the message queue. Consequently, the program code of the data subset retrieval module can be further enabled to determine from the request a specified one of the templates, to load the specified template in the memory, to map data in the retrieved message to a field in the specified one of the templates corresponding to the field specified by the request, and to transmit the mapped data to the requesting application as a data subset.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for data subset retrieval from a queued message;

FIG. 2 is a schematic illustration of a messaging queuing data processing system configured for data subset retrieval from a queued message; and,

FIG. 3 is a flow chart illustrating a process for data subset retrieval from a queued message.

### DETAILED DESCRIPTION OF THE INVENTION

Embodiments of the present invention provide a method, system and computer program product for data subset retrieval from a queued message. In accordance with an embodiment of the present invention, a template can specify different fields of a message in a message queue and can be used by the retrieval mechanism for the message queue to retrieve only a specified data subset in a message in the message queue. Specifically, upon receipt from a calling application of a retrieval request specifying both a template and one or more fields of a message, the specified template can be used to locate with a message one or more of the specified fields. Thereafter, the data located at the specified fields can be extracted from the message and returned to the calling application. In this way, the message queue paradigm can be expanded and enriched in functionality and efficiency by not requiring a calling application to retrieve all data in a message in a message queue.

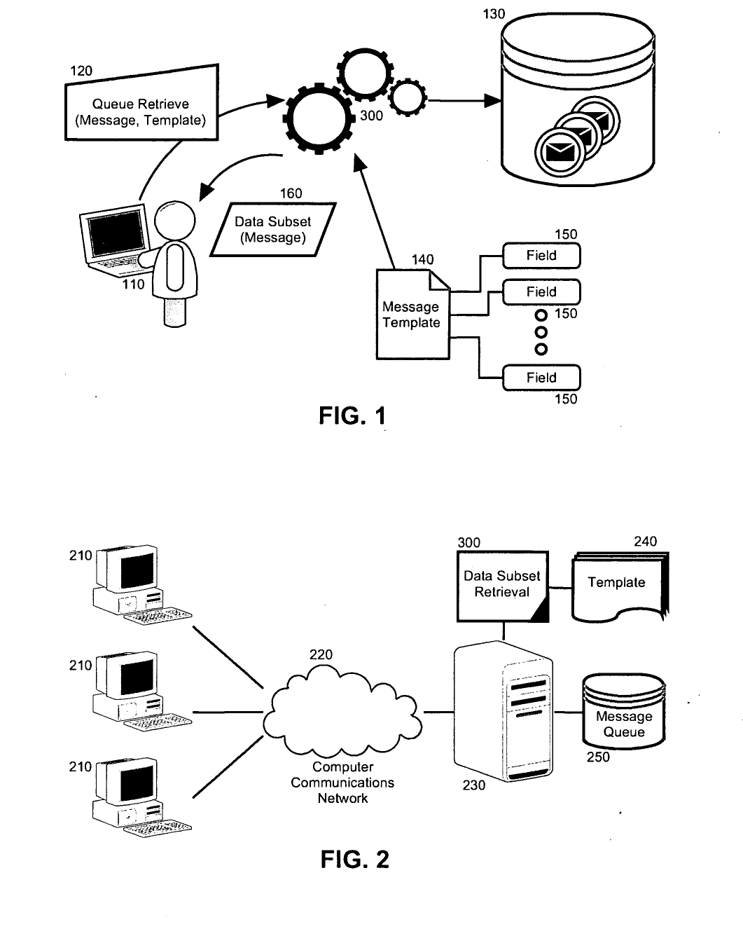

In further illustration, FIG. 1 pictorially shows a process for data subset retrieval from a queued message. As shown in FIG. 1, a calling application 110 can issue a message retrieval request 120 to a message in a message queue 130. Data subset retrieval module 300 can receive the request 120 and identify within the request a specification of a message template 140 or the request can include the message template 140 as part of the request. The message template 140 can indicate one or more different fields 150 in a message in the message queue 130. For example, each of the fields 150 can include a name or other identifier, an index into the message, and a length such that the data present in the message at the index and continuing for the length can map to the field 150.

The data subset retrieval module 300 can further identify within the request 120, one or more fields collectively representative of a data subset 160 of a message requested by the calling application 110. Thereafter, the data subset retrieval module 300 can retrieve the requested message from the message queue 130 and the data subset retrieval module 300 can extract there from a data subset 160 of data mapped to the specified fields in the request 120. Finally, the data subset retrieval module 300 can return the data subset 160 to the calling application 110.

The process described in connection with FIG. 1 can be implemented within a message queuing data processing system. In further illustration, FIG. 2 schematically depicts a messaging queuing data processing system configured for data subset retrieval from a queued message. The system can include one or more different client computing devices 210 communicatively coupled to a host computing system 230 over a computer communications network 220. The host computing system 230 can include one or more computing servers, each with memory and one or more processors and can support the operation of a message queue 250 such that requests for queued messages therein can be managed through the host computing system 230 and requested messages in the message queue 250 can be provided to applications executing in the client computing devices 210 requesting queued messages.

Data subset retrieval module 300 can execute as program code in memory by a processor in the host computing system 230. In this regard, data subset retrieval module 300 can include program code enabled to receive message retrieval requests from applications in the client computing devices 210 and to determine whether or not each of the requests specifies a message template 240 or includes a message template 240. The message template 240 can specify one or more fields in a message in the message queue 250, for instance by index and length. The program code of the data subset retrieval module 300 further can be enabled to locate a data subset within a requested message in the message queue 250 corresponding to one or more specified fields provided by a template specified by or included as part of the request. Finally, the program code of the data subset retrieval module 300 can be enabled to return to requesting applications in the client computing devices 210, located data subsets according to fields specified in respective requests for messages in the message queue 250.

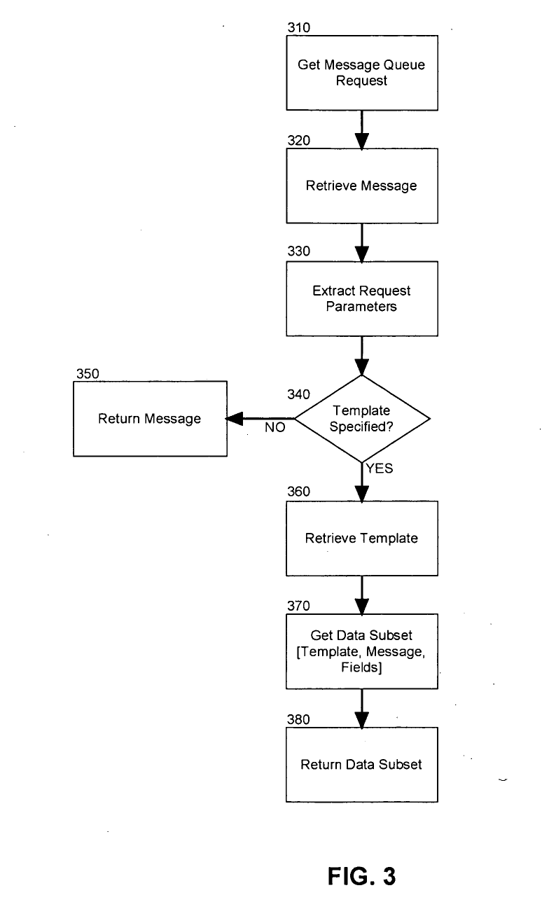

In yet further illustration of the operation of the data subset retrieval module 300, FIG. 3 is a flow chart illustrating a process for data subset retrieval from a queued message. Beginning in block 310, a message retrieval request can be received from a requesting application, the request specifying a message to be retrieved from a message queue. In block 320, the requested message can be retrieved from the message queue and loaded into memory. In block 330, parameters can be extracted from the message retrieval request to determine whether or not a template has been specified or included as part of the request and if so, one or more fields specified for retrieval from the message associated with the message retrieval request. In decision block 340, if no template has been specified in or included as part of the message retrieval request, in block 350 the retrieved message can be returned to the requesting application. Otherwise, the process can continue through block 360.

In block 360, a template specified by the message request or included as part of the message request can be retrieved and loaded into memory in order to map particular fields to portions of a message. In block 370, a data subset corresponding to the specified fields in the message request can be copied from the message. In this regard, to the extent that the template provides an index and length for each field, a length of data at each index in the message can be copied from the message for each field specified in the message retrieval request and combined in a data structure to form a data subset of the message. Thereafter, in block 380, the data subset can be returned to the requesting application.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for data subset retrieval from a queued message comprising:
receiving from a requesting application a message retrieval request for a message in a message queue;
retrieving the message from the message queue;
identifying a field specified by the request; and,
transmitting to the requesting application only data in the message corresponding to the identified field specified by the request.

2. The method of claim 1, wherein transmitting to the requesting application only data in the message corresponding to the at least one identified field specified by the request, comprises:
determining from the request a specified template;
loading the specified template in memory;
mapping data in the retrieved message to a field in the template corresponding to the field specified by the request; and,
transmitting the mapped data to the requesting application as a data subset.

3. The method of claim 1, wherein transmitting to the requesting application only data in the message corresponding to the at least one identified field specified by the request, comprises:
determining from the request a specified template included as part of the request;
loading the specified template in memory;
mapping data in the retrieved message to a field in the template corresponding to the field specified by the request; and,
transmitting the mapped data to the requesting application as a data subset.

4. A message queuing data processing system comprising:
a host computing system comprising a processor and memory;
a message queue coupled to the host computing system; and,
a data subset retrieval module executing in the host computing system, the module comprising program code enabled to receive from a requesting application a message retrieval request for a message in the message queue, to retrieve the message from the message queue, to identify a field specified by the request, and to transmit to the requesting application only data in the message corresponding to the identified field specified by the request.

5. The system of claim 4, further comprising a plurality of templates, each template comprising a plurality of fields in a message in the message queue, the program code of the data subset retrieval module being further enabled to determine from the request a specified one of the templates, to load the specified template in the memory, to map data in the retrieved message to a field in the specified one of the templates corresponding to the field specified by the request, and to transmit the mapped data to the requesting application as a data subset.

6. A computer program product comprising a computer usable medium embodying computer usable program code for data subset retrieval from a queued message, the computer program product comprising:
computer usable program code for receiving from a requesting application a message retrieval request for a message in a message queue;
computer usable program code for retrieving the message from the message queue;
computer usable program code for identifying a field specified by the request; and,
computer usable program code for transmitting to the requesting application only data in the message corresponding to the identified field specified by the request.

7. The computer program product of claim 6, wherein the computer usable program code for transmitting to the requesting application only data in the message corresponding to the at least one identified field specified by the request, comprises:
computer usable program code for determining from the request a specified template;
computer usable program code for loading the specified template in memory;
computer usable program code for mapping data in the retrieved message to a field in the template corresponding to the field specified by the request; and,
computer usable program code for transmitting the mapped data to the requesting application as a data subset.

8. The computer program product of claim 6, wherein the computer usable program code for transmitting to the requesting application only data in the message corresponding to the at least one identified field specified by the request, comprises:
computer usable program code for determining from the request a specified template included as part of the request;
computer usable program code for loading the specified template in memory;
computer usable program code for mapping data in the retrieved message to a field in the template corresponding to the field specified by the request; and,
computer usable program code for transmitting the mapped data to the requesting application as a data subset.
